(19) United States
(12) Patent Application Publication
(10) Pub. No.: US 2009/0272656 A1
(43) Pub. Date: Nov. 5, 2009

(54) Gas Sensor

(76) Inventors: Mark Varney, Hampshire (GB); Michael Garrett, Surrey (GB); Deryk Williams, Surrey (GB)

Correspondence Address: WILLIAMS MULLEN, 222 CENTRAL PARK AVENUE, SUITE 1700, VIRGINIA BEACH, VA, 23462, US

(21) Appl. No.: 12/446,046

(22) PCT Filed: Oct. 17, 2007
(86) PCT No.: PCT/GB2007/003957

§ 371 Date: Jun. 16, 2009

(30) Foreign Application Priority Data
Oct. 18, 2006 (GB) 0620711.2

(51) Int. Cl. G01N 27/26; G01N 27/28

(52) U.S. Cl. 205/785.5; 204/406

(57) ABSTRACT

A method for the determination of the carbon dioxide content of an exhaled gas stream is provided, the method comprising measuring the water vapour content of the exhaled gas stream, and determining the concentration of carbon dioxide in the exhaled gas stream from the measured water vapour content. A particular method comprises causing the gas stream to impinge on a sensing element comprising a working electrode and a counter electrode; applying an electric potential across the working electrode and counter electrode; measuring the current flowing between the working electrode and counter electrode as a result of the applied potential; and determining from the measured current flow an indication of the concentration of the water vapour in the gas stream. A sensor is also described.

The present invention is related to a sensor for detecting gaseous substances, in particular a sensor for detecting the presence of substances in a stream of gas exhaled by a patient or subject. The sensor is particularly suitable for, but not limited to, the analysis of the carbon dioxide content of the gas stream. The sensor finds particular use as a capnographic sensor for detecting and measuring the concentration of gases, such as carbon dioxide, in the exhaled breath of a person or animal, to thereby provide an indication of the condition of the respiratory system of a patient or subject and to assist in the identification and diagnosis of respiratory ailments or illness.

The analysis of the carbon dioxide content of the exhaled breath of a person or animal is a valuable tool in assessing the health of the subject. In particular, measurement of the carbon dioxide concentration allows the extent and/or progress of various pulmonary and/or respiratory diseases to be estimated, in particular asthma and chronic obstructive lung disease (COPD).

Carbon dioxide can be detected using a variety of analytical techniques and instruments. The most practical and widely used analysers use spectroscopic infra-red absorption as a method of detection, but the gas may also be detected using mass spectrometry, gas chromatography, thermal conductivity and others. Although most analytical instruments, techniques and sensors for carbon dioxide measurement are based on the physicochemical properties of the gas, new techniques are being developed which utilise electrochemistry, and an assortment of electrochemical methods have been proposed. However, it has not been possible to measure carbon dioxide (CO₂) gas directly using electrochemical techniques. Indirect methods have been devised, based on the dissolution of the gas into an electrolyte with a consequent change in the pH of the electrolyte. Other electrochemical methods use high temperature catalytic reduction of carbon dioxide. However, these methods are generally very expensive, cumbersome to employ and often display very low sensitivities and slow response times. These drawbacks render them inadequate for analyzing breath samples, in particular in the analysis of tidal breathing.

A more recently applied technique is to monitor a specific chemical reaction in an electrolyte that contains suitable organometallic ligands that chemically interact following the pH change induced by the dissolution of the carbon dioxide gas. The pH change then disturbs a series of reactions, and the carbon dioxide concentration in the atmosphere is then estimated indirectly according to the change in the acid-base chemistry.

Carbon dioxide is an acid gas, and interacts with water, and other (protic) solvents. For example, carbon dioxide dissolves in an aqueous solution according to the following reactions:

CO₂+H₂O [symbol] H₂CO₃ (1)

H₂CO₃ [symbol] HCO₃⁻+H⁺ (2)

HCO₃⁻ [symbol] CO₃²⁻+H⁺ (3)

It will be appreciated that, as more carbon dioxide dissolves, the concentration of hydrogen ions (H⁺) increases.

The use of this technique for sensing carbon dioxide has the disadvantage that when used for gas analysis in the gaseous phase the liquid electrolyte must be bounded by a semi-permeable membrane. The membrane is impermeable to water but permeable to various gases, including carbon dioxide. The membrane must reduce the evaporation of the internal electrolyte without seriously impeding the permeation of the carbon dioxide gas. The result of this construction is an electrode which works well for a short period of time, but has a long response time and in which the electrolyte needs to be frequently renewed.

WO 04/001407 discloses a sensor comprising a liquid electrolyte retained by a permeable membrane, which overcomes some of these disadvantages. However, it would be very desirable to provide a sensor that does not rely on the presence and maintenance of a liquid electrolyte.

U.S. Pat. No. 4,772,863 discloses a sensor for oxygen and carbon dioxide gases having a plurality of layers comprising an alumina substrate, a reference electrode source of anions, a lower electrical reference electrode of platinum coupled to the reference source of anions, a solid electrolyte containing tungsten and coupled to the lower reference electrode, a buffer layer for preventing the flow of platinum ions into the solid electrolyte and an upper electrode of catalytic platinum.

GB 2,287,543 A discloses a solid electrolyte carbon monoxide sensor having a first cavity formed in a substrate, communicating with a second cavity in which a carbon monoxide adsorbent is located. An electrode detects the partial pressure of oxygen in the carbon monoxide adsorbent. The sensor of GB 2,287,543 is very sensitive to the prevailing temperature and is only able to measure low concentrations of carbon monoxide at low temperatures with any sensitivity. High temperatures are necessary in order to measure carbon monoxide concentrations that are higher, if complete saturation of the sensor is to be avoided. This renders the sensor impractical for measuring gas compositions over a wide range of concentrations.

GB 2,316,178 A discloses a solid electrolyte gas sensor, in which a reference electrode is mounted within a cavity in the electrolyte. A gas sensitive electrode is provided on the outside of the solid electrolyte. The sensor is said to be useful in the detection of carbon dioxide and sulphur dioxide. However, operation of the sensor requires heating to a temperature of at least 200° C., more preferably from 300 to 400° C. This represents a major drawback in the practical applications of the sensor.

Sensors for use in monitoring gas compositions in heat treatment processes are disclosed in GB 2,184,549 A. However, as with the sensors of GB 2,316,178, operation at high temperatures (up to 600° C.) is disclosed and appears to be required.

Accordingly, there is a need for a sensor that does not rely on the presence of an electrolyte in the liquid phase or high temperature catalytic method, that is of simple construction and may be readily applied to monitor gas compositions at ambient conditions.

EP 0 293 230 discloses a sensor for detecting acidic gases, for example carbon dioxide. The sensor comprises a sensing electrode and a counter electrode in a body of electrolyte. The electrolyte is a solid complex having ligands that may be displaced by the acidic gas. A similar sensor arrangement is disclosed in U.S. Pat. No. 6,454,923.

A particularly effective sensor is disclosed in pending international application No. PCT/GB2005/003196. The sensor comprises a sensing element disposed to be exposed to the gas stream, the sensing element comprising a working electrode; a counter electrode; and a solid electrolyte precursor extending between and in contact with the working electrode and the counter electrode; whereby the gas stream may be caused to impinge upon the solid electrolyte precursor such that water vapour in the gas stream at least partially hydrates the precursor to form an electrolyte in electrical contact with the working electrode and the counter electrode.

It would be advantageous if the speed of response of the known sensors could be increased, while at the same time maintaining the accuracy of the sensors. In this respect, it is to be noted that carbon dioxide, a particularly preferred target molecule, in particular in the analysis of exhaled breath of patients and subjects, is a relatively large molecule, with a consequently low rate of mass transport to the sensing components of sensing devices.

The gas stream exhaled by a person or animal contains a range of components, including carbon dioxide and water vapour. It has been found that a strong relationship exists between the water vapour content of the exhaled gas stream and the carbon dioxide content of the gas stream.

Accordingly, in a first aspect, the present invention provides a method for the determination of the carbon dioxide content of an exhaled gas stream, the method comprising:

measuring the water vapour content of the exhaled gas stream; and

determining the concentration of carbon dioxide in the exhaled gas stream from the measured water vapour content.

As noted above, it has been found that as a result of respiration in the respiratory tract of a human or animal the concentration of carbon dioxide present in the exhaled gas stream is closely related to that of water, at a given temperature. Typically, the gas stream exhaled by a human contains approximately 79% nitrogen, 15% oxygen, 5% carbon dioxide and 2% water vapour, by volume. Thus, the ratio of carbon dioxide to water vapour in the exhaled gas is typically 2.5:1.

The ability to determine carbon dioxide concentration of exhaled gas streams from the detection and measurement of the water vapour content offers a number of advantages. First, of the individual components making up an exhaled gas stream, water is the only sub-critical gas component present and is thus readily condensable in a sensor. Further, as the water molecule is significantly smaller than the carbon dioxide molecule, its rate of diffusion and mass transfer is correspondingly faster, giving the potential for providing a sensor that has a fast response time. This is of importance when designing a sensor to be used on a regular basis by subjects, such as patients wishing to detect a respiratory disorder, for example an asthmatic wishing to identify the onset of an asthma attack.

The sensor used for measuring the concentration of the water vapour in the exhaled gas stream may be sensitive to water vapour alone. Alternatively, the sensor may be one that is sensitive to both water vapour and carbon dioxide, account of which is taken when processing the output of the sensor to determine the carbon dioxide concentration.

In the human or animal respiratory system, gas may be inhaled and exhaled either through the nasal passages or through the mouth. The nasal passages provide a mechanism for heat exchange and moisture exchange with the passing gas stream, which functions are not performed to the same extent by the structures of the mouth. Due to the different structures and their different functions, the composition of gas exhaled through the mouth will differ from that of a gas stream exhaled through the nose. In the present invention, it is preferred that the method of determining carbon dioxide concentration is performed in a gas stream exhaled through the mouth, in order to provide a result for use the assessment of respiratory function of the subject.

The method may employ any suitable technique for determining the moisture content of the exhaled gas stream. Suitable methods will be known to the person skilled in the art. One technique for the measurement the absolute humidity of exhaled gas streams is selected ion flow tube mass spectrometry (SIFT-MS), as disclosed by P. Spanel and D. Smith, ‘On-line measurement of the absolute humidity of air, breath and liquid headspace samples by selected ion flow tube mass spectrometry’, Rapid Communications in Mass Spectrometry, 2001, 15, pages 563 to 569.

In a further aspect, the present invention provides a sensor for determining the concentration of carbon dioxide in an exhaled gas stream, the sensor comprising:

means for determining the concentration of water vapour in the exhaled gas stream; and

means for calculating the concentration of carbon dioxide in the exhaled gas stream from the measured water vapour concentration.

As noted above, the sensor may employ any suitable technique for determining the concentration of water vapour in the exhaled gas stream. In a preferred embodiment, the present invention employs an electrochemical sensor. Suitable electrochemical sensors are known in the art and include sensors disclosed in the prior art documents discussed hereinbefore. In one embodiment, the electrochemical sensor comprises:

a sensing element disposed to be exposed to the gas stream, the sensing element comprising:

a working electrode; and

a counter electrode.

The electrodes may be uncoated and exposed directly to the gas stream. Alternatively, the electrodes may be coated with a suitable material to provide an electrochemical conductive path between the electrodes when water vapour is present in the gas stream.

In one preferred sensor, the electrodes are coated with a layer of ion exchange material extending between the working electrode and the counter electrode; whereby contact of the ion exchange layer with the gas stream forms an electrical contact between the working and counter electrodes.

In the present specification, references to an ion exchange material are to a material having ion exchange, properties, such that contact with the components of a gas stream results in a change in the conductivity of the layer between the electrodes. The ion exchange material acts as the support medium for electrical conduction to occur, as it allows a hydrated ionic layer to form between the electrodes. The layer of ion exchange material provides a medium that is highly controllable and hydrates uniformly to provide a suitable medium for conduction to occur.

Suitable ion exchange materials for use in the sensor of the present invention are those having a high proton conductivity, good chemical stability, and the ability to retain sufficient mechanical integrity. The ion exchange material should have a high affinity for the species present in the gas stream being analysed, in particular for the various components that are present in the exhaled breath of a subject or patient.

Suitable ion exchange materials are known in the art and are commercially available products.

Particularly preferred ion exchange material are the ionomers, a class of synthetic polymers with ionic properties. A particularly preferred group of ionomers are the sulphonated tetrafluoroethylene copolymers. An especially preferred ionomer from this class is Nafion®, available commercially from Du Pont. The sulphonated tetrafluroethylene copolymers have superior conductive properties due to their proton conducting capabilities. The sulphonated tetrafluroethylene copolymers can be manufactured with various cationic conductivities. They also exhibit excellent thermal and mechanical stability and are biocompatible, thus making them suitable materials for use in the controlled electrode coating.

Other suitable ion exchange materials include polyether ether ketones (PEEK), poly(arylene-ether-sulfones) (PSU), PVDF-graft styrenes, acid doped polybenimidazoles (PBI) and polyphosphazenes.

The ion exchange material may be present in the sensor in the dry state. Alternatively, the ion exchange material may be present with water in a saturated or partially-saturated state.

The thickness of the ion exchange material will determine the response of the sensor to changes in the composition of the gas stream in contact with the ion exchange layer. To minimize internal resistance within the sensor, it is preferred to use an ultra thin ion exchange layer.

The ion exchange layer may comprise a single ion exchange material or a mixture of two or more such materials, depending upon the particular application of the sensor.

The ion exchange layer may consist of the ion exchange material in the case the material exhibits the required level of chemical and mechanical stability and integrity for the working life of the sensor. Alternatively, the ion exchange layer may comprise an inert support for the ion exchange material. Suitable supports include oxides, in particular metal oxides, including aluminium oxide, titanium oxide, zirconium oxides and mixtures thereof. Other suitable supports include oxides of silicon and the various natural and synthetic clays.

In a second preferred embodiment, the electrodes of the sensor are coated in a layer of mesoporous material extending between the working electrode and the counter electrode; whereby contact of the mesoporous layer with the gas stream forms an electrical contact between the working and counter electrodes.

In the present specification, references to a mesoporous material are to a material having pores in the range of from 1 to 75 nm, more particularly in the range of from 2 to 50 nm. The mesoporous material acts as the support medium for electrical conduction to occur, as it allows a temporary hydrated ionic layer to form across the electrodes. The layer of mesoporous material provides a medium that is highly controllable and hydrates uniformly to provide a suitable medium for conduction to occur.

Suitable mesoporous materials for use in the sensor of the present invention include metal oxides, in particular oxides of metals from Group IV of the Periodic Table of the Elements, in particular oxides of titanium or zirconium. A particularly preferred metal oxide is titanium oxide, including the titanates, Alternative mesoporous materials of use are synthetic clays, of particular preference due to the inherent layered nature of the clays. Laponite is a synthetic layered silicate with a structure resembling that of the natural clay mineral, hectonite. When added to water with stirring it will disperse rapidly into nanoparticles. It is cost effective, heat stable, thixotropic and can retain levels of hydration. Laponite is of special interest because of its single ion conducting character, where concentration polarization can be minimised. Hydrotalcite-like compounds are known also as layered double hydroxides or anionic clays. These compounds have a layered crystal structure composed of positively charged hydroxide layers and interlayers containing anions and water molecules. These compounds exhibit anion-exchange properties and can recover the layered crystal structure during rehydration.

The mesoporous material may be present in the sensor in the dry state, in which case the material will require the addition of water, for example as water vapour present in the gas stream. Alternatively, the mesoporous material may be present with water in a saturated or partially-saturated state.

The thickness of the mesoporous material will determine the response of the sensor to changes in the composition of the gas stream in contact with the mesoporous layer. To minimize internal resistance within the sensor, it is preferred to use an ultra thin mesoporous layer.

The mesoporous material may comprise a binder, in particular a conductive (ion exchanger type) binder. Suitable conductive binders include ionomers, a class of synthetic polymers with ionic properties. A particularly preferred group of ionomers are the sulphonated tetrafluoroethylene copolymers. An especially preferred ionomer from this class is Nafion®, available commercially from Du Pont. The sulphonated tetrafluroethylene copolymers have superior conductive properties due to their proton conducting capabilities. The pores in the mesoporous material allow movement of cations but the membranes do not conduct anions or electrons. The sulphonated tetrafluroethylene copolymers can be manufactured with various cationic conductivities. They also exhibit excellent thermal and mechanical stability and are biocompatible, thus making them suitable materials for use in the controlled electrode coating.

A further sensor embodiment comprises a solid electrolyte precursor extending between and in contact with the working electrode and the counter electrode; whereby the gas stream may be caused to impinge upon the solid electrolyte precursor such that the water vapour in the gas stream at least partially hydrates the precursor to form an electrolyte in electrical contact with the working electrode and the counter electrode.

In the context of the present invention, the term ‘solid electrolyte precursor’ is a reference to a material that is in the solid phase under the conditions prevailing during the use of the sensor and that can react with (or be hydrated by) water vapour in the gas stream to reconstitute a hydrous electrolyte, allowing current to flow between the working electrode and counter electrode.

The solid electrolyte precursor comprises a ligand, preferably an organic ligand (hereafter denoted as ‘L’), which is capable of forming a complex with a metal ion (hereafter denoted as ‘M’) to form an organometallic complex. Within the electrolyte, the organic ligand is capable of dissociation according to the following equations:

LH₂ [symbol] LH⁻+H⁺

LH⁻ [symbol] L²⁻+H⁺

A wide range of ligands and metal ions may be employed in the organometallic complex of the solid electrolyte precursor. Preferred organic compounds for use as the ligand are amines, in particular diamines, such as diaminopropane, and carboxylic acids, especially dicarboxylic acids. The metal ions are preferably ions of Group VIII of the Periodic Table of the Elements (as provided in the Handbook of Chemistry and Physics, 62^{nd} edition, 1981 to 1982, Chemical Rubber Company). Suitable metals include copper, lead and cadmium.

The solid electrolyte precursor preferably also comprises a salt. Metal halide salts are preferred, in particular sodium and potassium halides, especially chlorides.

The specific choice and combination of metal ions and organic ligands may be theoretically calculated using principles of equilibrium (speciation) chemistry. The principle determinand is that the ligand should have a low pK_{b}. As noted above, a preferred class of ligand is the diamines, for example, propanediamine, ethylenediamine and various substituted diamines, The performance of the sensor is dependant on the choice and concentration of metal/ligand pairs and the optimum precursor composition may be found by routine experimentation.

A particularly preferred composition for the solid electrolyte precursor comprises copper, propanediamine and potassium chloride. One preferred composition has these components present in the following amounts: 4 mM copper, 10 mM propanediamine, and 0.1M potassium chloride as base electrolyte.

It will be appreciated by those skilled in the art that there are a considerable range and combination of other metals, ligands, and base electrolytes.

The solid electrolyte precursor may be prepared from a solution of the constituent components in a suitable solvent. Water is a most convenient solvent. The solvent is removed by drying and evaporation, to leave the solid electrolyte precursor. Evaporation of the solvent may be assisted by blowing a gas stream, such as air or nitrogen, across the surface of the drying precursor.

The present invention provides a sensor that is particularly compact and of very simple construction. In addition, the sensor may be used at ambient temperature conditions, without the need for any heating or cooling, while at the same time producing an accurate measurement of the target substance concentration in the gas being analysed.

The sensor preferably comprises a housing or other protective body to enclose and protect the electrodes. The sensor may comprise a passage or conduit to direct the stream of gas directly onto the electrodes. In a very simple arrangement, the sensor comprises a conduit or tube into which the two electrodes extend, so as to be contacted directly by the gaseous stream passing through the conduit or tube. When the sensor is intended for use in the analysis of the breath of a patient, the conduit may comprise a mouthpiece, into which the patient may exhale. Alternatively, the sensor may be formed to have the electrodes in an exposed position on or in the housing, for direct measurement of a bulk gas stream. The precise form of the housing, passage or conduit is not critical to the operation or performance of the sensor and may take any desired form. It is preferred that the body or housing of the sensor is prepared from a non-conductive material, such as a suitable plastic.

The electrodes may have any suitable shape and configuration. Suitable forms of electrode include points, lines, rings and flat planar surfaces. The effectiveness of the sensor can depend upon the particular arrangement of the electrodes and may be enhanced in certain embodiments by having a very small path length between the adjacent electrodes. This may be achieved, for example, by having each of the working and counter electrodes comprise a plurality of electrode portions arranged in an alternating, interlocking pattern, that is in the form of an array of interdigitated electrode portions, in particular arranged in a concentric pattern.

The electrodes are preferably oriented as close as possible to each other, to within the resolution of the manufacturing technology. The working and counter electrode can be between 10 to 1000 microns in width, preferably from 50 to 500 microns. The gap between the working and counter electrodes can be between 20 and 1000 microns, more preferably from 50 to 500 microns. The optimum track-gap distances are found by routine experiment for the particular electrode material, geometry, configuration, and substrate under consideration. In a preferred embodiment the optimum working electrode track widths are from 50 to 250 microns, preferably about 100 microns, and the counter electrode track widths are from 50 to 750 microns, preferably about 500 microns. The gaps between the working and counter electrodes are preferably about 100 microns.

The counter electrode and working electrode may be of equal size. However, in one preferred embodiment, the surface area of the counter electrode is greater than that of the working electrode to avoid restriction of the current transfer. Preferably, the counter electrode has a surface area at least twice that of the working electrode. Higher ratios of the surface area of the counter electrode and working electrode, such as at least 3:1, preferably at least 5:1 and up to 10:1 may also be employed. The thickness of the electrodes is determined by the manufacturing technology, but has no direct influence on the electrochemistry. The magnitude of the resultant electrochemical signal is determined principally by exposed surface area, that is the surface area of the electrodes directly exposed to and in contact with the gaseous stream. Generally, an increase in the surface area of the electrodes will result in a higher signal, but may also result in increased susceptibility to noise and electrical interference. However, the signals from smaller electrodes may be more difficult to detect.

The electrodes may be supported on a substrate. Suitable materials for the support substrate are any inert, non-conducting material, for example ceramic, plastic, or glass. The substrate provides support for the electrodes and serves to keep them in their proper orientation. Accordingly, the substrate may be any suitable supporting medium. It is important that the substrate is non-conducting, that is electrically insulating or of a sufficiently high dielectric coefficient.

The electrodes may be disposed on the surface of the substrate, with the layer of ion exchange material extending over the electrodes and substrate surface. Alternatively, the ion exchange material may be applied directly to the substrate, with the electrodes being disposed on the surface of the ion exchange layer. This would have the advantage of providing mechanical strength and a thin layer of base giving greater control of path length.

The ion exchange material is conveniently applied to the surface of the substrate by evaporation from a suspension or solution in a suitable solvent. For example, in the case of sulphonated tetrafluoroethylene copolymers, a suitable solvent is methanol. The suspension or solution of the ion exchange material may also comprise the inert support or a precursor thereof, if one is to be present in the ion exchange layer.

To improve the electrical insulation of the electrodes, the portions of the electrodes that are not disposed to be in contact with the gaseous stream (that is the non-operational portions of the electrodes) may be coated with a dielectric material, patterned in such a way as to leave exposed the active portions of the electrodes.

While the sensor operates well with two electrodes, as hereinbefore described, arrangements with more than two electrodes, for example including a third or reference electrode, as is well known in the art. The use of a reference electrode provides for better potentiostatic control of the applied voltage, or the galvanostatic control of current, when the “iR drop” between the counter and working electrodes is substantial. Dual 2-electrode and 3-electrode cells may also be employed.

A further electrode, disposed between the counter and working electrodes, may also be employed. The temperature of the gas stream may be calculated by measuring the end-to-end resistance of the electrode. Such techniques are known in the art.

The electrodes may comprise any suitable metal or alloy of metals, with the proviso that the electrode does not react with the electrolyte or any of the substances present in the gas stream. Preference is given to metals in Group VIII of the Periodic Table of the Elements (as provided in the Handbook of Chemistry and Physics, 62^{nd} edition, 1981 to 1982, Chemical Rubber Company). Preferred Group VIII metals are rhenium, palladium and platinum. Other suitable metals include silver and gold. Preferably, each electrode is prepared from gold or platinum. Carbon or carbon-containing materials may also be used to form the electrodes.

The electrodes of the sensor of the present invention may be formed by printing the electrode material in the form of a thick film screen printing ink onto the substrate. The ink consists of four components, namely the functional component, a binder, a vehicle and one or more modifiers. In the case of the present invention, the functional component forms the conductive component of the electrode and comprises a powder of one or more of the aforementioned metals used to form the electrode.

The binder holds the ink to the substrate and merges with the substrate during high temperature firing. The vehicle acts as the carrier for the powders and comprises both volatile components, such as solvents and non-volatile components, such as polymers. These materials evaporate during the early stages of drying and firing respectively. The modifiers comprise small amounts of additives, which are active in controlling the behaviour of the inks before and after processing.

Screen printing requires the ink viscosity to be controlled within limits determined by rheological properties, such as the amount of vehicle components and powders in the ink, as well as aspects of the environment, such as ambient temperature.

The printing screen may be prepared by stretching stainless steel wire mesh cloth across the screen frame, while maintaining high tension. An emulsion is then spread over the entire mesh, filling all open areas of the mesh. A common practice is to add an excess of the emulsion to the mesh. The area to be screen printed is then patterned on the screen using the desired electrode design template.

The squeegee is used to spread the ink over the screen. The shearing action of the squeegee results in a reduction in the viscosity of the ink, allowing the ink to pass through the patterned areas onto the substrate. The screen peels away as the squeegee passes. The ink viscosity recovers to its original state and results in a well defined print. The screen mesh is critical when determining the desired thick film print thickness, and hence the thickness of the completed electrodes.

The mechanical limit to downward travel of the squeegee (downstop) should be set to allow the limit of print stroke to be 75-125 um below the substrate surface. This will allow a consistent print thickness to be achieved across the substrate whilst simultaneously protecting the screen mesh from distortion and possible plastic deformation due to excessive pressure.

To determine the print thickness the following equation can be used:

Tw=(Tm×Ao)+Te

### Where

Tw=Wet thickness (um);

Tm=mesh weave thickness (um);

Ao=% open area;

Te=Emulsion thickness (um).

After the printing process the sensor element needs to be leveled before firing. The leveling permits mesh marks to fill and some of the more volatile solvents to evaporate slowly at room temperature. If all of the solvent is not removed in this drying process, the remaining amount may cause problems in the firing process by polluting the atmosphere surrounding the sensor element. Most of the solvents used in thick film technology can be completely removed in an oven at 150° C. when held there for 10 minutes.

Firing is typically accomplished in a belt furnace. Firing temperatures vary according to the ink chemistry. Most commercially available systems fire at 850° C. peak for 10 minutes. Total furnace time is 30 to 45 minutes, including the time taken to heat the furnace and cool to room temperature. Purity of the firing atmosphere is critical to successful processing. The air should be clean of particulates, hydrocarbons, halogen-containing vapours and water vapour.

Alternative techniques for preparing the electrodes and applying them to the substrate, if present, include spin/sputter coating and visible/ultraviolet/laser photolithography. In order to avoid impurities being present in the electrodes, which may alter the electrochemical performance of the sensor, the electrodes may be prepared by electrochemical plating. In particular, each electrode may be comprised of a plurality of layers applied by different techniques, with the lower layers be prepared using one of the aforementioned techniques, such as printing, and the uppermost or outer layer or layers being applied by electrochemical plating using a pure electrode material, such as a pure metal.

In use, the sensor is able to operate over a wide range of temperatures.

In a further aspect, the present invention provides a method of determining the carbon dioxide content of an exhaled gas stream comprising water vapour, the method comprising:

causing the gas stream to impinge on a sensing element comprising a working electrode and a counter electrode;

applying an electric potential across the working electrode and counter electrode;

measuring the current flowing between the working electrode and counter electrode as a result of the applied potential;

determining from the measured current flow an indication of the concentration of water vapour in the gas stream; and

determining the concentration of carbon dioxide in the exhaled gas stream from the measured water vapour concentration.

During operation, the impedance between the counter and working electrodes indicates the relative humidity and, if being measured, the target substance content of the gaseous stream, which may be electronically measured by a variety of techniques.

The method of the present invention may be carried out using a sensor as hereinbefore described.

The method requires that an electric potential is applied across the electrodes. In one simple configuration, a voltage is applied to the counter electrode, while the working electrode is connected to earth (grounded). In its simplest form, the method applies a single, constant potential difference across the working and counter electrodes. Alternatively, the potential difference may be varied against time, for example being pulsed or swept between a series of potentials. In one embodiment, the electric potential is pulsed between a so-called ‘rest’ potential, at which no reaction occurs, and a reaction potential.

In operation, a linear potential scan, multiple voltage steps or one discrete potential pulse are applied to the working electrode, and the resultant Faradaic reduction current is monitored as a direct function of the dissolution of target molecules in the water bridging the electrodes.

The measured current in the sensor element is usually small. The current is converted to a voltage using a resistor, R. As a result of the small current flow, careful attention to electronic design and detail may be necessary. In particular, special “guarding” techniques may be employed. Ground loops need to be avoided in the system. This can be achieved using techniques known in the art.

The current that passes between the counter and working electrodes is converted to a voltage and recorded as a function of the carbon dioxide concentration in the gaseous stream. The sensor responds faster by pulsing the potential between two voltages, a technique known in the art as ‘Square Wave Voltammetry’. Measuring the response several times during a pulse may be used to assess the impedance of the sensor.

The shape of the transient response can be simply related to the electrical characteristics (impedance) of the sensor in terms of simple electronic resistance and capacitance elements. By careful analysis of the shape, the individual contributions of resistance and capacitance may be calculated. Such mathematical techniques are well known in the art. Capacitance is an unwanted noisy component resulting from electronic artifacts, such as charging, etc. The capacitive signal can be reduced by selection of the design and layout of the electrodes in the sensor. Increasing the surface area of the electrodes and increasing the distance between the electrodes are two major parameters that affect the resultant capacitance. The desired Faradaic signal resulting from the passage of current due to reaction between the electrodes may be optimized, by experiment. Measurement of the response at increasing periods within the pulse is one technique that can preferentially select between the capacitive and Faradaic components, for instance. Such practical techniques are well known in the art.

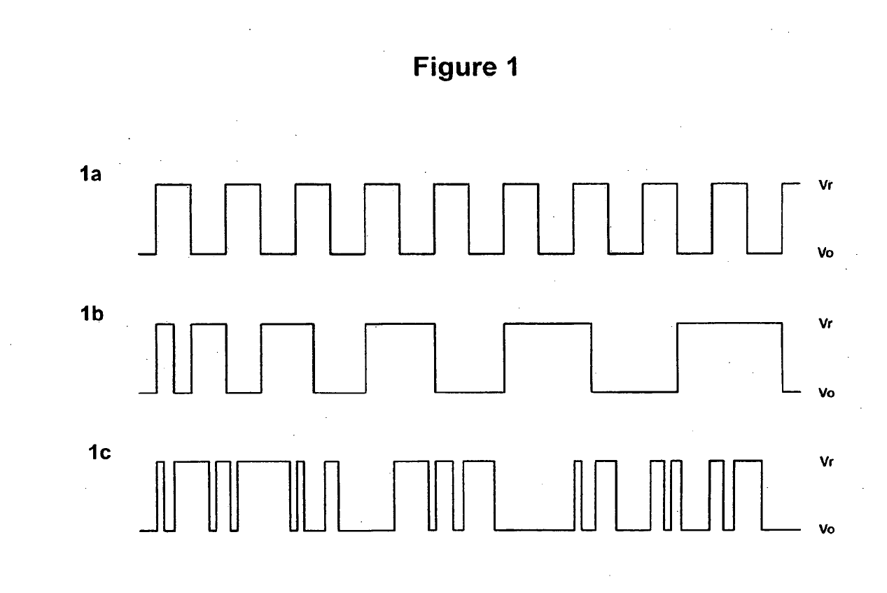

The potential difference applied to the electrodes of the sensor element may be alternately or be periodically pulsed between a rest potential and a reaction potential, as noted above. FIG. 1 shows examples of voltage waveforms that may be applied. FIG. 1a is a representation of a pulsed voltage signal, alternating between a rest potential, V₀, and a reaction potential V_{R}. The voltage may be pulsed at a range of frequencies, typically from sub-Hertz frequencies, that is from 0.1 Hz, up to 10 kHz. A preferred pulse frequency is in the range of from 1 to 500 Hz. Alternatively, the potential waveform applied to the counter electrode may consist of a “swept” series of frequencies, represented in FIG. 1b. A further alternative waveform shown in FIG. 1c is a so-called “white noise” set of frequencies. The complex frequency response obtained from such a waveform will have to be deconvoluted after signal acquisition using techniques such as Fourier Transform analysis. Again, such techniques are known in the art.

One preferred voltage regime is 0V (“rest” potential), 250 mV (“reaction” potential), and 20 Hz pulse frequency.

It is an advantage of the present invention that the electrochemical reaction potential is approximately +0.2 volts, which avoids many if not all of the possible competing reactions that would interfere with the measurements, such as the reduction of metal ions and the dissolution of oxygen.

The method of the present invention is particularly suitable for use in the analysis of the exhaled breath of a person or animal. From the results of this analysis, an indication of the respiratory condition of the patient may be obtained.

The sensor and method of the present invention are of use in monitoring and determining the lung function of a patient or subject. The method and sensor are particularly suitable for analyzing tidal concentrations of carbon dioxide in the exhaled breath of a person or animal, to diagnose or monitor a variety of respiratory conditions. The sensor is particularly useful for applications requiring fast response times, for example personal respiratory monitoring of tidal breathing (capnography). Capnographic measurements can be applied generally in the field of respiratory medicine, airway diseases, both restrictive and obstructive, airway tract disease management, and airway inflammation. The present invention finds particular application in the field of capnography and asthma diagnosis, monitoring and management, where the shape of the capnogram changes as a function of the extent of the disease. In particular, due to the high rate of response that may be achieved using the sensor and method of the present invention, the results may be used to provide an early alert to the onset of an asthma attack in an asthmatic patient.

Embodiments of the present invention will now be described, by way of example only, having reference to the accompanying drawings, in which:

FIGS. 1a, 1b and 1c are voltage versus time representations of possible voltage waveforms that may be applied to the electrodes in the method of the present invention, as discussed hereinbefore;

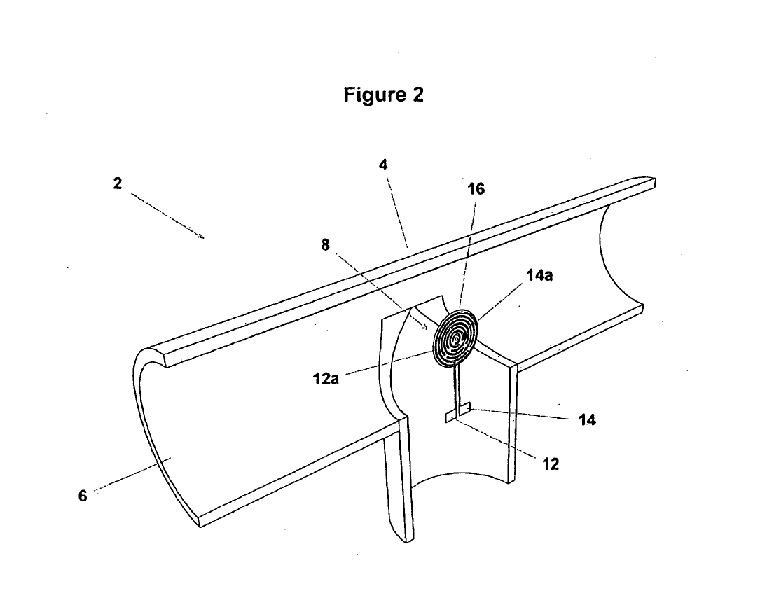

FIG. 2 is a cross-sectional representation of one embodiment of the sensor of the present invention;

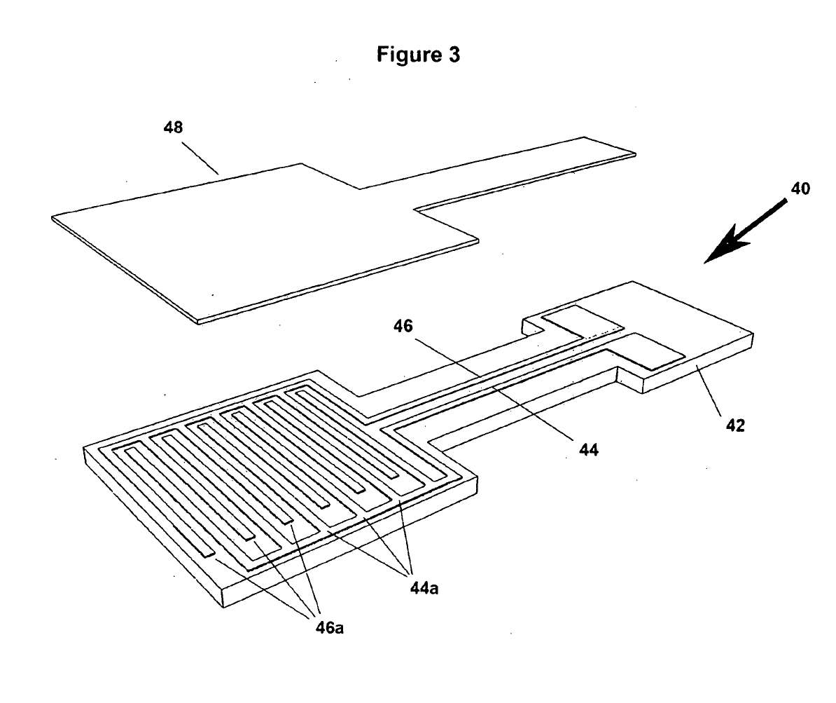

FIG. 3 is an isometric schematic view of a face of one embodiment of the sensor element according to the present invention;

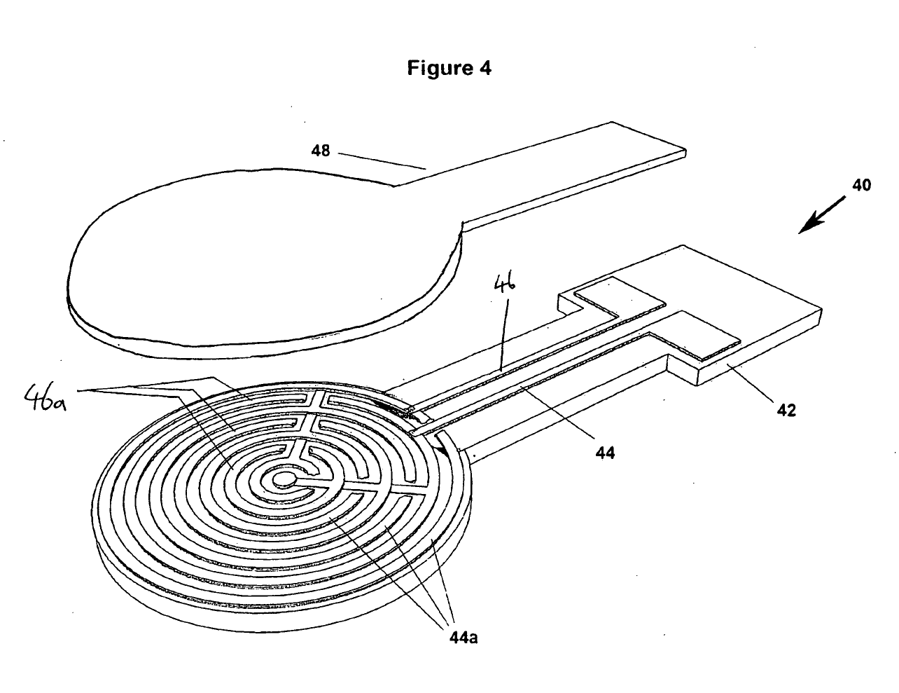

FIG. 4 is an isometric schematic view of an alternative embodiment of the sensor element of the sensor of the present invention;

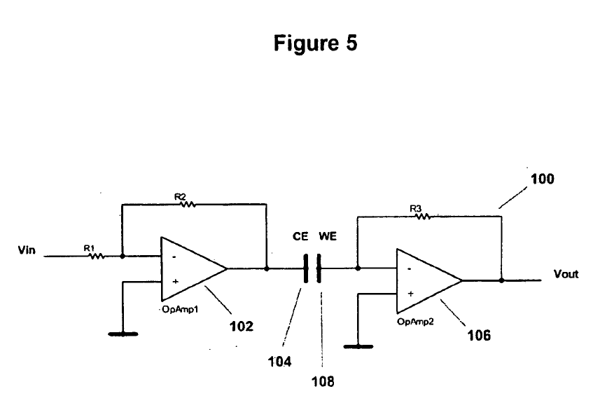

FIG. 5 is a schematic view of a potentiostat electronic circuit that may be used to excite the electrodes of the sensor element;

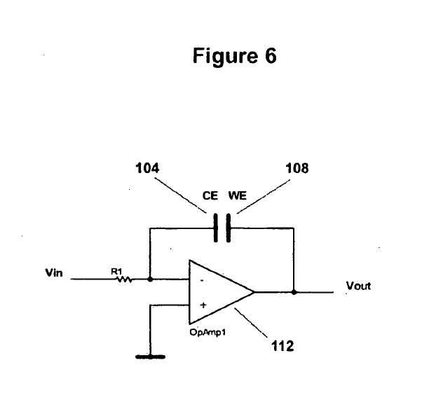

FIG. 6 is a schematic view of a galvanostat electronic circuit that may be used to excite the electrodes;

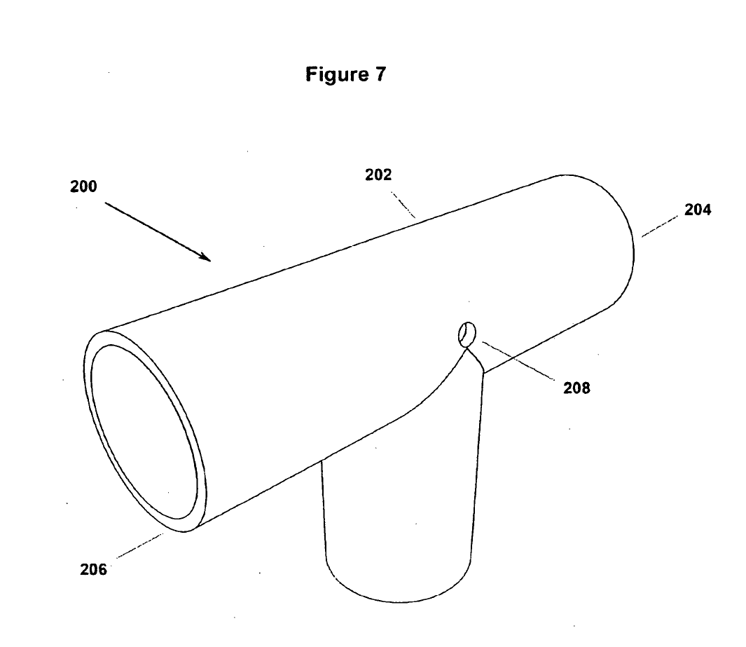

FIG. 7 is a schematic representation of a breathing tube adaptor for use in the sensor of the present invention;

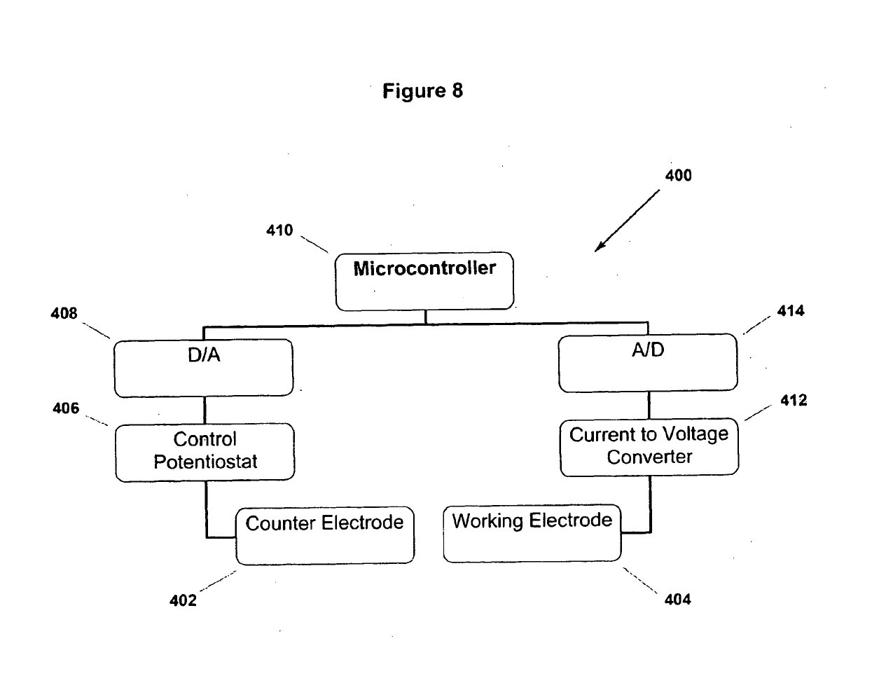

FIG. 8 is a flow-diagram providing an overview of the inter-connection of sensor elements and their connection into a suitable measuring instrument of an embodiment of the present invention; and

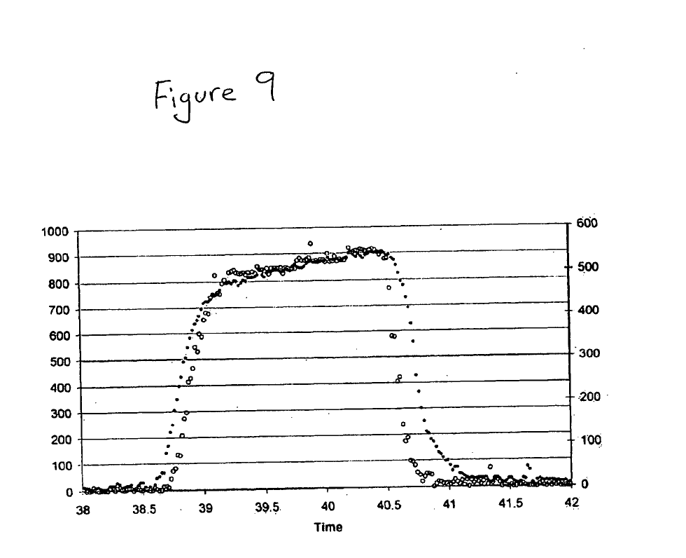

FIG. 9 is a graphical representation of the output from an experiment to measure the water and carbon dioxide content of exhaled breath.

Referring to FIG. 2, there is shown a sensor according to the present invention. The sensor is for analyzing the carbon dioxide content and humidity of exhaled breath. The sensor, generally indicated as 2, comprises a conduit 4, through which a stream of exhaled breath may be passed. The conduit 4 comprises a mouthpiece 6, into which the patient may breathe.

A sensing element, generally indicated as 8, is located within the conduit 4, such that a stream of gas passing through the conduit from the mouthpiece 6 is caused to impinge upon the sensing element 8. The sensing element 8 comprises a support substrate 10 of an inert material, onto which is mounted a working electrode 12 and a reference electrode 14. The working electrode 12 and reference electrode 14 each comprise a plurality of electrode portions, 12a and 14a, arranged in concentric circles, so as to provide an interwoven pattern minimizing the distance between adjacent portions of the working electrode 12 and reference electrode 14. In this way, the current path between the two electrodes is kept to a minimum.

A layer 16 of insulating or dielectric material extends over a portion of both the working and counter electrodes 12 and 14, leaving the portions 12a and 14a of each electrode exposed to be in contact with a stream of gas passing through the conduit 4. The arrangement of the support, electrodes 12 and 14, and the coating applied to the electrodes is shown in more detail in FIGS. 3 and 4.

Referring to FIG. 3, there is shown an exploded view of a sensor element, generally indicated as 40, comprising a substrate layer 42. A working electrode 44 is mounted on the substrate layer 42 from which extend a series of elongated electrode portions 44a. Similarly, a reference electrode 46 is mounted on the substrate layer 42 from which extends a series of electrode portions 46a. As will be seen in FIG. 3, the working electrode portions 44a and the reference electrode portions 46a extend one between the other in an intimate, interdigitated array, providing a large surface area of exposed electrode with minimum separation between adjacent portions of the working and reference electrodes. A layer 48 of coating material, for example an ion exchange material, electrolyte precursor, zeolite or mesoporous clay, overlies the working and reference electrodes 44, 46.

The coating material 48 is applied by the repeated immersion in a suspension or slurry of the coating material in a suitable solvent. The sensor element is dried to evaporate the solvent after each immersion and before the subsequent immersion. Other materials may be incorporated into the coating by subsequent immersion in additional solutions or suspensions. The number of immersions is determined by the required thickness of the coating, and the chemical composition is determined by the number and variety of additional solutions that the sensor is dipped into.

It will be obvious that there are a number of other means whereby the thickness and composition of the coating may be similarly achieved, such as: pad, spray, screen and other mechanical methods of printing. Such techniques are well known in the field.

An alternative electrode arrangement is shown in FIG. 4, in which components common to the sensor element of FIG. 3 are identified with the same reference numerals. It will be noted that the working electrode portions 44a and the reference electrode portions 46a are arranged in an intimate circular array. The electrodes and substrate are coated as described above in relation to FIG. 3.

Referring to FIG. 5, there is shown a potentiostat electronic circuit that may be employed to provide the voltage applied across the working and reference electrodes of the sensor of the present invention. The circuit, generally indicated as 100, comprises an amplifier 102, identified as ‘OpAmp1’, acting as a control amplifier to accept an externally applied voltage signal Vᵢₙ. The output from OpAmp1 is applied to the control (counter) electrode 104. A second amplifier 106, identified as ‘OpAmp2’ converts the passage of current from the counter electrode 104 to the working electrode 108 into a measurable voltage (Vₒᵤₜ). Resistors R1, R2 and R3 are selected according to the input voltage, and measured current.

An alternative galvanostat circuit for exciting the electrodes of the sensor is shown in FIG. 6. The control and working electrodes 104 and 108 are connected between the input and output of a single amplifier 112, indicated as ‘OpAmp1’. Again, resistor R1 is selected according to the desired current.

Turning to FIG. 7, an adaptor for monitoring the breath of a patient is shown. A sensor element is mounted within the adaptor and oriented directly into the air stream flowing through the adaptor, in a similar manner to that shown in FIG. 2 and described hereinbefore. The preferred embodiment illustrated in FIG. 7 comprises and adaptor, generally indicated as 200, having a cylindrical housing 202 having a male-shaped (push-fit) cone coupling 204 at one end and a female-shaped (push-fit) cone coupling 206 at the other. A side inlet 208 is provided in the form of an orifice in the cylindrical housing 202, allowing for the adaptor to be used in the monitoring of the tidal breathing of a patient, as described in more detail in Example 2 below. The side inlet 208 directs gas onto the sensor element during inhalation by a patient through the device. The monitoring of tidal breathing may be improved by the provision of a one-way valve on the outlet of the housing 202.

With reference to FIG. 8 there is shown in schematic form the general layout of a sensor system according to the present invention. The system, generally indicated as 400, comprises a sensor element having a counter electrode 402 and a working electrode 404. The counter electrode 402 is supplied with a voltage by a control potentiostat 406, for example of the form shown in FIG. 5 and described hereinbefore. The input signal for the control potentiostat 406 is provided by a digital-to-analog converter (D/A) 408, itself being provided with a digital input signal from a microcontroller 410. The output signal generated by the sensing element is in the form of a current at the working electrode 404, which is fed to a current-to-voltage converter 412, the output of which is in turn fed to an analog-to-digital converter (A/D) 414. The microcontroller 410 receives the output of the A/D converter 414, which it employs to generate a display indicating the concentration of the target substance in the gas stream being monitored. The display (not shown in FIG. 8 for reasons of clarity) may be any suitable form of display, for example an audio display or visual display. In one preferred embodiment, the microcontroller 410 generates a continuous display of the concentration of the target substance, this arrangement being particularly useful in the monitoring of the tidal breathing of a patient.

The present invention will be further illustrated by the following specific example.

### EXAMPLE

An analysis of the water and carbon dioxide content of exhaled breath of a subject was obtained as follows:

The breath exhaled by a subject was analysed for its carbon dioxide content by infrared mass spectroscopy techniques using known techniques and an Oxicap Model 4700 mass spectrometer (commercially available apparatus, Datex-Ohmeda, Louisville, Colo.). The results of the analysis are represented graphically in FIG. 9.

The same breath of the same subject was analysed for water content using a sensor as hereinbefore described and shown in the accompanying figures. The sensor comprises two electrodes with a coating comprising zeolite and nafion, as described. The analysis of the breath was conducted by having the subject breath into a mouthpiece as shown in FIG. 7, in which was installed an electrochemical sensor of the aforementioned construction. The output of the sensor is shown graphically in FIG. 9.

Referring to FIG. 9, the results of the analysis for a single exhaled breath of the subject are shown in the graph. The data points relating to carbon dioxide content are shown in light circles, while those relating to water content are shown in dark circles. The scales of the data points have been adjusted to achieve the best overlay of the two traces. The figure shows that there is a very strict correlation between the water content of the breath with the carbon dioxide concentration, throughout the entire exhaled breath. The profile of the trace has the shape of a typical capnogram, as would be expected when measuring the change in carbon dioxide content throughout the exhaled breath. It can be seen that the profile of the trace for water concentration follows that for carbon dioxide almost exactly throughout the entire breath.

It will be noted that the width of the profile of the two traces is different, with the trace for water being slightly wider than that for carbon dioxide. This difference is explained by, the arrangement of conduits used to direct the exhaled breath to the relevant sensor apparatus. As noted, the subject exhaled through a mouthpiece and conduit as shown in FIG. 7. Thus, the electrochemical sensor was placed in the mainstream of the exhaled breath. In order to provide a stream for analysis to the mass spectrometer, a sample of the exhaled breath was taken as a sidestream and pumped to the spectrometer inlet.

It will thus be appreciated, that a knowledge of the concentration of one of carbon dioxide or water in the exhaled breath of a subject and details of the correlation between the two, as shown in FIG. 9, allows the concentration of the other component to be readily determined. This represents a significant finding and offers a significant improvement in the techniques available to measure and analyse the composition of the breath exhaled by a subject. This in turn will greatly assist medical practitioners in diagnosing a range of respiratory disorders.

1. A method for the determination of the carbon dioxide content of an exhaled gas stream, the method comprising:
measuring the water vapour content of the exhaled gas stream; and
determining the concentration of carbon dioxide in the exhaled gas stream from the measured water vapour content.

2. The method according to claim 1, wherein the exhaled gas stream is exhaled from the mouth of the subject.

3. The method according to claim 1, wherein the water vapour content is measured using an electrochemical sensor.

4. The method of claim 3 further comprising:
causing the gas stream to impinge on a sensing element comprising a working electrode and a counter electrode;
applying an electric potential across the working electrode and counter electrode;
measuring the current flowing between the working electrode and counter electrode as a result of the applied potential; and
determining from the measured current flow an indication of the concentration of the water vapour in the gas stream.

5. The method of claim 4, wherein a constant voltage is applied across the working electrode and the counter electrode.

6. The method of claim 4, wherein a variable voltage is applied across the working electrode and the counter electrode.

7. The method of claim 6, wherein the variable voltage alternates between a rest potential and a potential above the reaction threshold potential.

8. The method of claim 7, wherein the voltage is pulsed at a frequency of from 0.1 Hz to 20 kHz.

9. A sensor for determining the concentration of carbon dioxide in an exhaled gas stream, the sensor comprising:
means for determining the concentration of water vapour in the exhaled gas stream; and
means for calculating the concentration of carbon dioxide in the exhaled gas stream from the measured water vapour concentration.

10. The sensor according to claim 9, further comprising:
a sensing element disposed to be exposed to the gas stream, the sensing element comprising: a working electrode; and a counter electrode.

11. The sensor according to claim 10, further comprising a conduit through which the gas stream is channeled to impinge upon the sensing element.

12. The sensor according to claim 11, wherein the conduit comprises a mouthpiece into which a patient may exhale.

13. The sensor according to claim 10, wherein the working electrode and counter electrode are in a form selected from a point, a line, rings and flat planar surfaces.

14. The sensor according to claim 10, wherein one or both of the working electrode and the counter electrode comprises a plurality of electrode portions.

15. The sensor according to claim 14, wherein both the working electrode and the counter electrode comprise a plurality of electrode portions arranged in an interlocking pattern.

16. The sensor according to claim 15, wherein the electrode portions are further arranged in a concentric pattern.

17. The sensor according to claim 10, wherein the surface area of the counter electrode is greater than the surface area of the working electrode.

18. The sensor according to claim 17, wherein the ratio of the surface area of the counter electrode to the working electrode is at least 2:1.

19. The sensor according to claim 10, wherein the electrodes are supported on an inert substrate.

20. The sensor according to claim 10, wherein each electrode comprises a metal selected from Group VIII of the Periodic Table of the Elements, copper, silver, platinum and gold.

21. The sensor according to claim 10, further comprising a layer of insulating material disposed over a portion of each electrode, the insulating layer being so shaped as to leave a portion of each electrode exposed for contact with a gas stream.

22. The sensor according to claim 10, further comprising a reference electrode.

23. The sensor according to claim 10, wherein the electrodes are mounted on a substrate, the electrodes being applied to the substrate by thick film screen printing, spin/sputter coating or visible/ultraviolet/laser photolithography.

24. The sensor according to claim 10, wherein one or more electrodes is comprised of a plurality of layers, the outer layer being a layer of pure metal applied by electrochemical plating.

25. A system for monitoring the composition of a gas stream comprising:
a sensor disposed to be exposed to the gas stream, the sensor comprising:
means for determining the concentration of water vapour in the exhaled gas stream;
means for calculating the concentration of carbon dioxide in the exhaled gas stream from the measured water vapour concentration; and
a working electrode; and a counter electrode;
a microcontroller for receiving an output from the sensor; and
a display;
wherein the microcontroller is programmed to generate a continuous image of the concentration of carbon dioxide in the gas stream being analysed on the display.
